(19) United States
(12) Patent Application Publication
(10) Pub. No.: US 2024/0014737 A1
(43) Pub. Date: Jan. 11, 2024

(54) EFFICIENT BOOTSTRAPPING FOR DC-DC CONVERTERS

(71) Applicant: Intel Corporation, Santa Clara, CA (US)

(72) Inventor: Sally Safwat Amin, Hillsboro, OR (US)

(21) Appl. No.: 17/858,281

(22) Filed: Jul. 6, 2022

(51) Int. Cl. H02M 3/156

(52) U.S. Cl. CPC H02M 3/156

(57) ABSTRACT

The circuits and methods described herein provide technical solutions for technical problems facing DC-DC converters. A self-timed active bootstrap driver may be used within a DC-DC converters to reduce or eliminate effects associated with passive bootstrap DC-DC converters. The self-timed active bootstrap driver improves or maximizes power efficiency by using available CMOS devices to sense the inductor node voltage Vx and using this information to turn ON the self-timed active bootstrap switch only at the falling edge of Vx node or when Vx close to “0,” which ensures that BST switch is turned ON when HS switch is OFF and Vx<VBS. This self-timed active bootstrap driver avoids the situation where Vx>VBS or where both HS switch and the BST switch are ON at the same time, and therefore reduces or minimizers efficiency penalties and circuit component aging and reliability issues that may result from bootstrapping.

### TECHNICAL FIELD

Embodiments described herein generally relate to power management integrated circuits (PMICs), such as direct current to direct current (DC-DC) converter circuits.

### BACKGROUND

Gallium nitride (GaN) and laterally-diffused metal-oxide semiconductor (LDMOS) based DC-DC converters may provide improved figures of merit and high voltage performance over complementary metal-oxide-semiconductor (CMOS) DC-DC converters. In GaN and LDMOS DC-DC converters, n-channel metal-oxide-semiconductor field-effect transistor (MOSFET) devices (N-device) may be used in both low side (LS) and high side (HS) circuit regions. During an inductor charging phase of GaN and LDMOS DC-DC converters, a bootstrap procedure may be used to turn ON (e.g., activate) the HS MOSFET N-device (e.g., HS switch). A bootstrap capacitor (CBS) may be used to deliver a charge to the HS driver while maintaining driver voltage (Vdrv) across the CBS during operation.

A passive bootstrap process may include a Zener diode-based bootstrap, where the Zener diode turns OFF when the BST capacitor terminal voltage is higher than Vdrv, which seeks to prevent current flow from HS input voltage Vin to Vdrv. However, the Zener diode bootstrap results in sinking substantial current to ground, especially in high Vin and high load current (ILd) condition, which results in significant efficiency degradation. Additionally, power loss in the Zener diode bootstrap is proportional to switching frequency (Fsw), resulting in increasing energy losses for increasingly high Fsw converters.

Another time-based bootstrap may include using a fixed dead-time between turning OFF the HS switch and turning ON the BST switch. Yet another time-based bootstrap may include calibrating the turn-on time of BST switch manually off-chip to reduce power losses during switching. However, fixed deadtime or manual off-chip dead-time calibration both result in substantial power losses for wide ILd range or across various combinations of process, voltage, and temperature (PVT) because the high-to-low transition time of the inductor terminal (Vx) node is dependent on ILd and the BST is switched ON only when Vx is lower than Vdrv or close to 0. Additionally, the mismatch and variation of signal path delay between the bootstrap switch and HS switch make fixed dead-time not viable solution for high-Vin and high-Fsw DC-DC converters that can support a wide ILd range. What is needed is an improved DC-DC converter.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1A-1C are circuit diagrams illustrating DC-DC converter phases, according to an embodiment.

FIGS. 2A-2C are circuit and timing diagrams illustrating DC-DC converter driver functionality, according to an embodiment.

FIG. 3 shows graphs illustrating a bootstrap switch gate signal timing diagram, according to an embodiment.

FIG. 4 shows graphs illustrating a BST switch and HS switch control signal timing diagram, according to an embodiment.

FIG. 5 is a flowchart illustrating a method for DC-DC conversion, according to an embodiment.

FIG. 6 is a block diagram of a computing device, according to an embodiment.

### DETAILED DESCRIPTION

The circuits and methods described herein provide technical solutions for technical problems facing DC-DC converters. A self-timed active bootstrap driver may be used within a DC-DC converters to reduce or eliminate effects associated with passive bootstrap DC-DC converters. The self-timed active bootstrap driver improves or maximizes power efficiency by using available CMOS devices to sense the inductor Vx node and using the Vx information to turn ON the self-timed active bootstrap (BST) switch only at the falling edge of Vx node or when Vx close to “0,” which ensures that BST switch is turned ON when HS switch is OFF and Vx<VBS. This self-timed active bootstrap driver avoids the situation where Vx>VBS or where both HS switch and the BST switch are ON at the same time, and therefore reduces or minimizers efficiency penalties and circuit component aging and reliability issues that may result from bootstrapping. This self-timed active bootstrap driver provides further improvements by being independent of ILd and Vin changes, and provides the ability to respond (e.g., switch) within a single cycle.

The self-timed active bootstrap driver provides a reliable power management integrated circuit (PMIC) solution with high power density that can operate in increasingly high frequency ranges and high input voltage ranges. This self-timed active bootstrap driver may improve overall power efficiency and reduce silicon area by eliminating the need for two stage converters. The self-timed active bootstrap driver may enable the use of increasingly high input voltage (Vin) and may reduce or minimize input current, which in turn substantially reduces power distribution losses (RLoss) in higher current application, such as in servers and GPUs. The self-timed active bootstrap driver may enable increasingly high switching frequencies and reduce die area and die cost, such as by decoupling and inductor size and improving load line performance. The self-timed active bootstrap driver may further facilitate magnetic material-based inductors, which may reduce or eliminate silicon area required for the inductor footprint.

In the following description, for purposes of explanation, numerous specific details are set forth to provide a thorough understanding of some example embodiments. It will be evident, however, to one skilled in the art that the present disclosure may be practiced without these specific details.

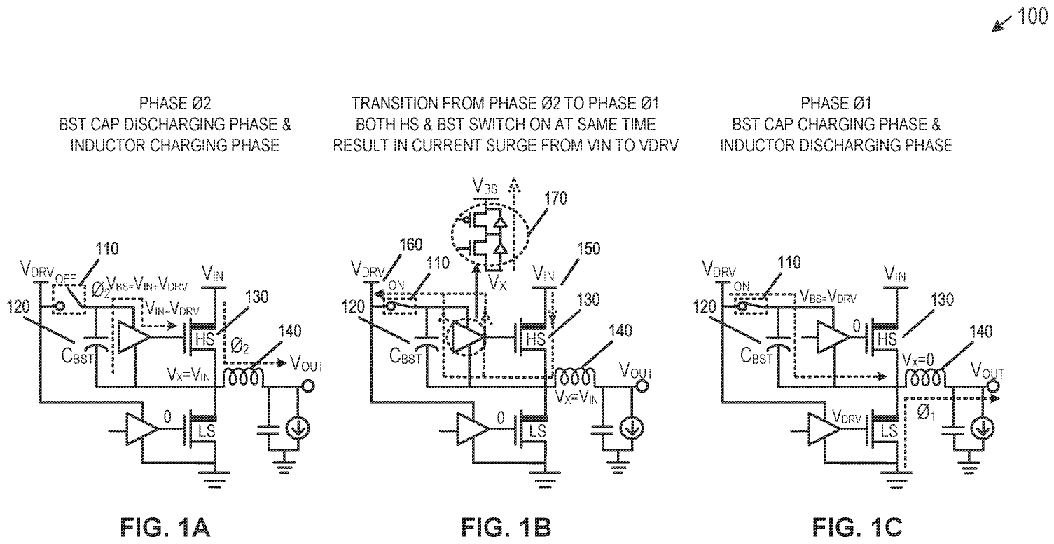

FIGS. 1A-1C are circuit diagrams illustrating DC-DC converter phases 100, according to an embodiment. FIG. 1A shows phase Ø2, FIG. 1B shows a transition between phase Ø2 and phase Ø1, and FIG. 1C shows phase Ø1. In phase Ø2 shown in FIG. 1A, the BST switch 110 is open to discharge the BST capacitor 120, and the HS switch 130 is closed to charge the inductor 140. Conversely, in phase Ø1 shown in FIG. 1C, the BST switch 110 is closed to charge the BST capacitor 120, and the HS switch 130 is open to discharge the inductor 140.

In the transition between phase Ø2 and phase Ø1 shown in FIG. 1B, both the HS switch 130 and BST switch 110 are ON at the same time. This may result in a current flowing from Vin 150 and Vdrv 160 across the BST capacitor 120 and the HS driver device diodes 170. However, the current flowing from Vin 150 and Vdrv 160 may result in efficiency degradation and increased HS driver device aging, reducing the lifetime of the DC-DC converter.

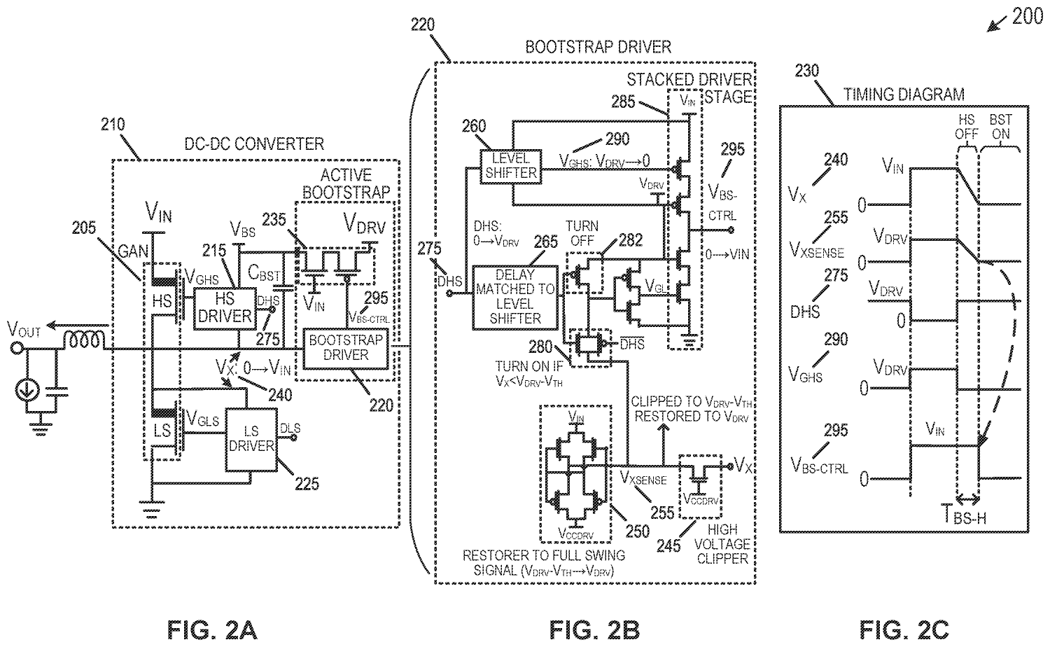

FIGS. 2A-2C are circuit and timing diagrams illustrating DC-DC converter driver functionality 200, according to an embodiment. FIG. 2A shows a circuit architecture of DC-DC converter 210. FIG. 2B shows additional circuit details of a self-timed bootstrap driver 220 within the DC-DC converter 210. FIG. 2C shows a timing diagram 230 of the operation of the various nodes within DC-DC converter 210 and within self-timed bootstrap driver 220.

As shown in FIG. 2A, the DC-DC converter 210 includes a GaN/LDMOS power train 205, where the power train HS is coupled to a HS driver 215 and the power train LS is coupled to a LS driver 225. The DC-DC converter 210 further includes a bootstrap switch 235 coupled to the bootstrap driver 220.

As shown in FIG. 2B, the bootstrap driver 220, the Vx signal 240 provided from the DC-DC converter 210 to the bootstrap driver 220 is coupled to a high voltage clipper 245 that includes a single transistor whose gate is coupled to Vccdrv. The high voltage clipper 245 is coupled to a restorer circuit 250 that includes back-to-back inverters. As shown in FIG. 2C, the high voltage clipper 245 and restorer circuit 250 convert the Vx signal 240 switching between “0” and “Vin” to a Vxsense signal 255 switching between “0” and “Vdrv.” While the Vx signal 240 may exceed the maximum allowable CMOS voltage, the clipped and restored version of the Vxsense signal 255 ensures that no transistor within the bootstrap driver 220 exceed the maximum CMOS voltage.

The bootstrap driver 220 further includes a level shifter 260 and a delay circuit 265 that receive a HS driver signal 275. A first delayed switch circuit 280 receives a delayed signal from the delayed circuit, the Vxsense signal 255, and a compliment of the HS driver signal, and turns ON when Vx<Vdrv −Vth. Similarly, a second delayed switch circuit 282 receives the delayed signal from the delayed circuit and turns OFF when Vx<Vdrv−Vth. A stacked driver stage 285 is coupled to the level shifter 260, to the first delayed switch circuit 280, and to the second delayed switch circuit 282. When the Vghs signal 290 generated by level shifter 260 transitions from Vdrv back to “0” and the Vxsense signal 255 subsequently transitions from Vdrv back to “0,” then the stacked driver stage 285 switches a Vbs-ctrl signal 295 from Vin to “0.” This Vbs-ctrl signal 295 is provided from the bootstrap driver 220 back to the bootstrap switch 235, which pulls down the gate of bootstrap PMOS switch. By pulling down the Vbs-ctrl signal 295 when the Vxsense signal 255 returns to “0,” this ensures that the bootstrap switch turns ON only when HS is OFF and the Vx signal 240 is “0.” This improved bootstrapping functionality reduces or minimizers power losses or circuit component aging. While this improves the performance of GaN and LDMOS DC-DC converters, this may also be used to improve the performance of any DC-DC converter that includes n-channel devices in both low side (LS) and high side (HS) circuit regions.

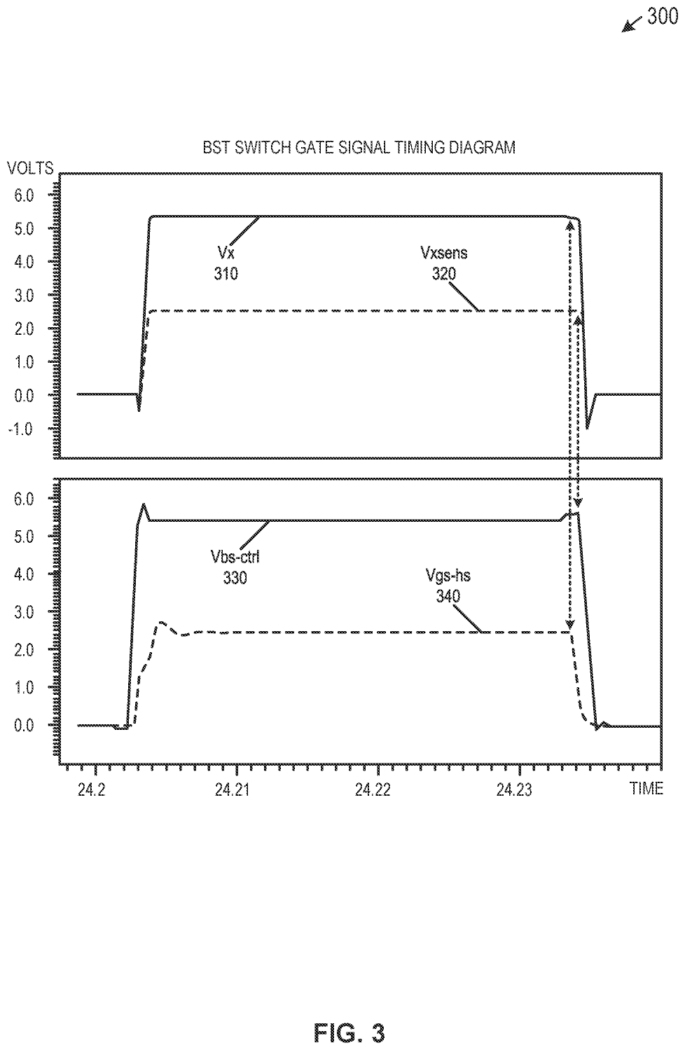

FIG. 3 shows graphs illustrating a bootstrap switch gate signal timing diagram 300, according to an embodiment. The timing diagram 300 shows simulation results of the signals shown within DC-DC converter 210 and self-timed bootstrap driver 220, including the inductor switching node Vx 310, sensed clipped signal Vxsense 320, gate voltage of PMOS bootstrap PMOS switch Vbs-ctrl 330, and gate-to-source voltage of HS switch Vgs-hs 340. As shown in FIG. 3, the falling edge of Vbs-ctrl 330 that turns ON the BST switch is triggered by the falling edge of Vxsense 320 and occurs when Vgs-hs 340 returns to “0” (e.g., when HS switch is turned OFF). By pulling down the Vbs-ctrl signal 330 when to the Vxsense signal 255 returns to “0,” this ensures that the bootstrap switch turns ON only when HS is OFF, this improved bootstrapping functionality reduces or minimizers power losses or circuit component aging.

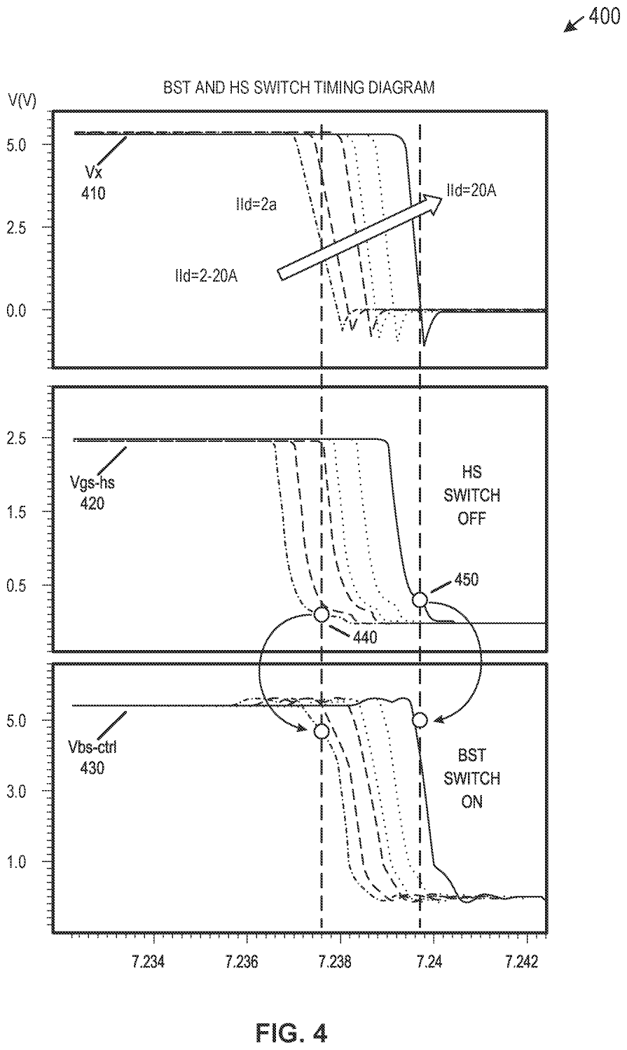

FIG. 4 shows graphs illustrating a BST switch and HS switch control signal timing diagram 400, according to an embodiment. The timing diagram 400 shows simulation results of the signals shown within DC-DC converter 210 and self-timed bootstrap driver 220, including the inductor switching node Vx 410, gate-to-source voltage of HS switch Vgs-hs 420, and gate voltage of PMOS bootstrap PMOS switch Vbs-ctrl 430. Each of the graphs shows these signals at different current load (Ild) conditions. As shown in FIG. 4., the Ild conditions shown in Vx 410 increase from left to right, and include Ild conditions of 2A, 4A, 6A, 10A, 14A, and 20A. For each of these increasing Ild conditions, the time delay of the Vx 410 negative edge increases. The negative edge of Vbs-ctrl 430 changes adaptively with this change of Vx 410 negative edge. For example, using the first Ild condition of 2A, at first time 440 when Vgs-hs 420 falls to “0” and the HS switch transitions to OFF, this corresponds to the BST switch transitioning to ON and the falling edge of Vbs-ctrl 430. Similarly, using the last Ild condition of 20A, at second time 450 when Vgs-hs 420 falls to “0” and the HS switch transitions to OFF, this corresponds to the BST switch transitioning to ON and the falling edge of Vbs-ctrl 430. This demonstrates that the improved bootstrapping functionality operates seamlessly and adaptively to changes in ILd conditions and Vin values, resulting in a robust bootstrapping functionality that can operate over various timing and load current operating conditions.

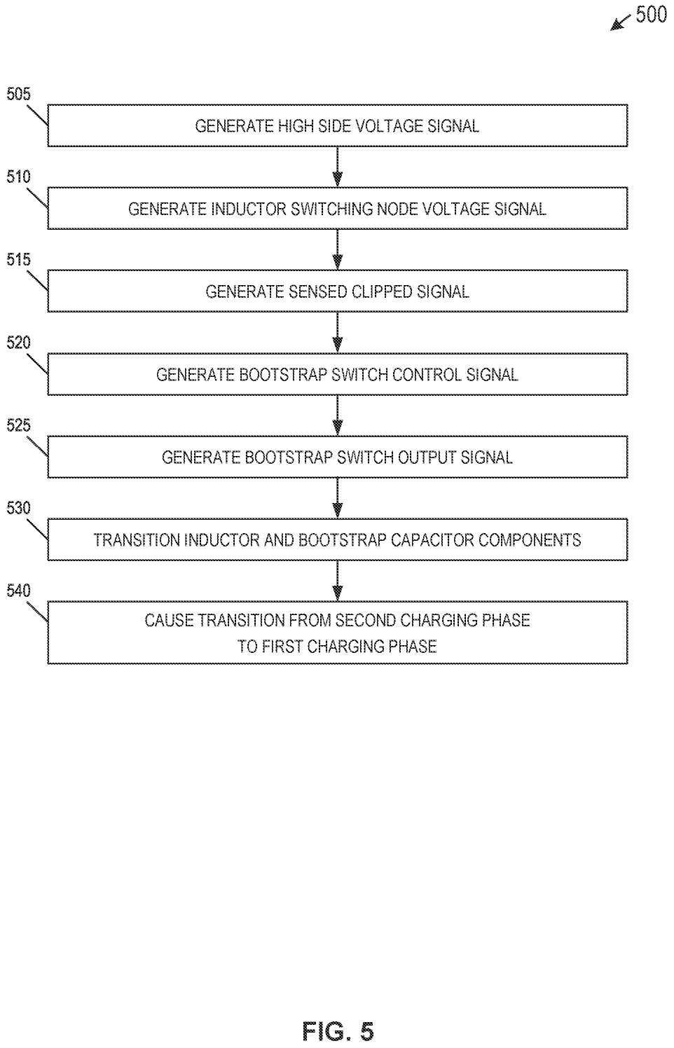

FIG. 5 is a flowchart illustrating a method for DC-DC conversion 500, according to an embodiment. Method 500 includes generating 505 a high side voltage signal at a high side driver, where the high side driver is coupled to a power train and to an inductor component. Method 500 includes generating 510 an inductor switching node voltage signal at the power train based on an input voltage, where the power train is coupled to the inductor component.

Method 500 may include generating 515 a sensed clipped signal based on the inductor switching node voltage signal. The sensed clipped signal may be generated at a high voltage clipper and a restorer circuit within the bootstrap driver. The sensed clipped signal may be used in generating the bootstrap switch control signal. The sensed clipped signal may share a plurality of voltage transitions with the inductor switching node voltage signal. The sensed clipped signal may include a maximum clipped voltage that is lower than a maximum inductor voltage.

Method 500 includes generating 520 a bootstrap switch control signal at a bootstrap driver based on the inductor switching node voltage signal and the high side voltage signal. The bootstrap driver may be coupled to the high side driver and to the power train. Method 500 includes generating 525 a bootstrap switch output signal at a bootstrap switch. The bootstrap switch may be coupled to the bootstrap driver and to a bootstrap capacitor component. Method 500 includes transitioning 530 the inductor component and a bootstrap capacitor component between a first charging phase and a second charging phase in response to the bootstrap switch output signal. Method 500 may include causing 540 a transition from the second charging phase to the first charging phase when the inductor switching node voltage signal has returned to the base inductor voltage level.

The second charging phase may include discharging the bootstrap capacitor component and includes charging the inductor component. The first charging phase may include charging the bootstrap capacitor component and includes discharging the inductor component. The power train may include at least one of a gallium nitride (GaN) power train and a laterally-diffused metal-oxide semiconductor (LDMOS) power train.

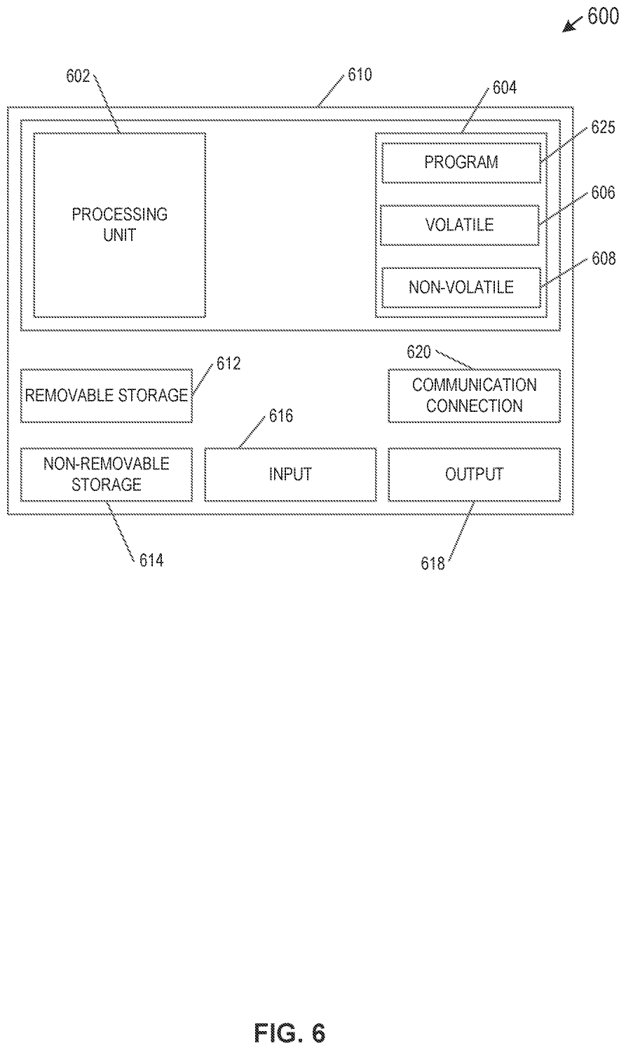

FIG. 6 is a block diagram of a computing device 600, according to an embodiment. The performance of one or more components within computing device 600 may be improved by including one or more of the circuits or circuitry methods described herein. Computing device 600 may include a voltage converter to generate an output voltage based on an input voltage. The voltage converter may include an inductive voltage output circuit including an inductor component. The inductive voltage output circuit may generate an output voltage based on an inductor switching node voltage signal received at the inductor component. The voltage converter may include a bootstrap driver coupled to the inductive voltage output circuit, the bootstrap driver to generate the inductor switching node voltage signal. The inductor switching node voltage signal may cause the inductive voltage output circuit to transition the output voltage between a first output level to a second output level.

In one embodiment, multiple such computer systems are used in a distributed network to implement multiple components in a transaction-based environment. An object-oriented, service-oriented, or other architecture may be used to implement such functions and communicate between the multiple systems and components. In some embodiments, the computing device of FIG. 6 is an example of a client device that may invoke methods described herein over a network. In other embodiments, the computing device is an example of a computing device that may be included in or connected to a motion interactive video projection system, as described elsewhere herein. In some embodiments, the computing device of FIG. 6 is an example of one or more of the personal computer, smartphone, tablet, or various servers.

One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, or other computing device including the same or similar elements as illustrated and described with regard to FIG. 6. Further, although the various data storage elements are illustrated as part of the computer 610, the storage may include cloud-based storage accessible via a network, such as the Internet.

Returning to the computer 610, memory 604 may include volatile memory 606 and non-volatile memory 608. Computer 610 may include or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The input 616 may include one or more of a touchscreen, touchpad, mouse, keyboard, camera, and other input devices. The input 616 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 620 to connect to one or more remote computers, such as database servers, web servers, and another computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs 625 or apps, such as one or more applications and modules implementing one or more of the methods illustrated and described herein or an app or application that executes on a mobile device or is accessible via a web browser, may be stored on a non-transitory computer-readable medium.

The apparatuses and methods described above may include or be included in high-speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only: C only; A and B (excluding C); A and C (excluding B); B and C (excluding A); or all of A, B, and C. Item A may include a single element or multiple elements. Item B may include a single element or multiple elements. Item C may include a single element or multiple elements.

In the detailed description and the claims, a list of items joined by the term “one of” may mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A may include a single element or multiple elements. Item B may include a single element or multiple elements. Item C may include a single element or multiple elements.

### Additional Notes and Examples

Example 1 is an apparatus comprising: a voltage converter to convert an input voltage into an output voltage, the voltage converter including: a power train coupled to the input voltage and to an inductor component, the power train to generate an inductor switching node voltage signal; a high side driver coupled to the power train and to the inductor component, the high side driver to generate a high side voltage signal; a bootstrap driver coupled to the high side driver and to the power train, the bootstrap driver to generate a bootstrap switch control signal based on the inductor switching node voltage signal and the high side voltage signal; a bootstrap capacitor component coupled to the high side driver and to the bootstrap driver; and a bootstrap switch coupled to the bootstrap driver and to the bootstrap capacitor component, the bootstrap switch to transition the inductor component and the bootstrap capacitor component between a first charging phase and a second charging phase based on the bootstrap switch control signal.

In Example 2, the subject matter of Example 1 includes, wherein the bootstrap driver is further to: determine when the inductor switching node voltage signal has returned to a base inductor voltage level; and the bootstrap switch control signal causes a transition from the second charging phase to the first charging phase when the inductor switching node voltage signal has returned to the base inductor voltage level.

In Example 3, the subject matter of Examples 1-2 includes, the bootstrap driver further including a high voltage clipper and a restorer circuit to generate a sensed clipped signal based on the inductor switching node voltage signal, wherein the bootstrap switch control signal is generated based on the sensed clipped signal.

In Example 4, the subject matter of Example 3 includes, wherein: the sensed clipped signal shares a plurality of voltage transitions with the inductor switching node voltage signal; and the sensed clipped signal includes a maximum clipped voltage that is lower than a maximum inductor voltage.

In Example 5, the subject matter of Examples 1-4 includes, the bootstrap driver further including: a level shifter and a delay circuit to generate a delayed signal based on the high side voltage signal; a first delayed switch circuit and a second delayed switch circuit to generate a switched signal based on the delayed signal; and a stacked driver stage to generate the bootstrap switch control signal based on the switched signal.

In Example 6, the subject matter of Examples 1-5 includes, wherein: the second charging phase includes discharging the bootstrap capacitor component and includes charging the inductor component; and the first charging phase includes charging the bootstrap capacitor component and includes discharging the inductor component.

In Example 7, the subject matter of Examples 1-6 includes, wherein the power train includes at least one of a gallium nitride (GaN) power train and a laterally-diffused metal-oxide semiconductor (LDMOS) power train.

Example 8 is a method comprising: generating a high side voltage signal at a high side driver, the high side driver coupled to a power train and to an inductor component; generating an inductor switching node voltage signal at the power train based on an input voltage, the power train coupled to the inductor component; generating a bootstrap switch control signal at a bootstrap driver based on the inductor switching node voltage signal and the high side voltage signal, the bootstrap driver coupled to the high side driver and to the power train; generating a bootstrap switch output signal at a bootstrap switch coupled to the bootstrap driver and to a bootstrap capacitor component; and transitioning the inductor component and a bootstrap capacitor component between a first charging phase and a second charging phase in response to the bootstrap switch output signal.

In Example 9, the subject matter of Example 8 includes, determining, at the bootstrap driver, subsequent to generating the inductor switching node voltage signal, the inductor switching node voltage signal has returned to a base inductor voltage level; wherein transitioning the inductor component and the bootstrap capacitor component includes causing a transition from the second charging phase to the first charging phase when the inductor switching node voltage signal has returned to the base inductor voltage level.

In Example 10, the subject matter of Examples 8-9 includes, generating a sensed clipped signal, at a high voltage clipper and a restorer circuit within the bootstrap driver, the sensed clipped signal generated prior to the bootstrap switch control signal based on the inductor switching node voltage signal, wherein the bootstrap switch control signal is generated based on the sensed clipped signal.

In Example 11, the subject matter of Example 10 includes, wherein: the sensed clipped signal shares a plurality of voltage transitions with the inductor switching node voltage signal; and the sensed clipped signal includes a maximum clipped voltage that is lower than a maximum inductor voltage.

In Example 12, the subject matter of Examples 8-11 includes, generating, at a level shifter and a delay circuit within the bootstrap driver, a delayed signal based on the high side voltage signal; generating, at a first delayed switch circuit and a second delayed switch circuit within the bootstrap driver, a switched signal based on the delayed signal; and generating, at a stacked driver stage within the bootstrap driver, the bootstrap switch control signal based on the switched signal.

In Example 13, the subject matter of Examples 8-12 includes, wherein: the second charging phase includes discharging the bootstrap capacitor component and includes charging the inductor component; and the first charging phase includes charging the bootstrap capacitor component and includes discharging the inductor component.

In Example 14, the subject matter of Examples 8-13 includes, wherein the power train includes at least one of a gallium nitride (GaN) power train and a laterally-diffused metal-oxide semiconductor (LDMOS) power train.

Example 15 is an apparatus comprising: a voltage converter to generate an output voltage based on an input voltage, the voltage converter including: an inductive voltage output circuit including an inductor component, the inductive voltage output circuit to generate an output voltage based on an inductor switching node voltage signal received at the inductor component; and a bootstrap driver coupled to the inductive voltage output circuit, the bootstrap driver to generate the inductor switching node voltage signal; wherein the inductor switching node voltage signal causes the inductive voltage output circuit to transition the output voltage between a first output level to a second output level.

In Example 16, the subject matter of Example 15 includes, the voltage converter further including: a power train coupled to the input voltage and to an inductor component, the power train to generate an inductor switching node voltage signal; a high side driver coupled to the power train and to the inductor component, the high side driver to generate a high side voltage signal; a bootstrap capacitor component coupled to the high side driver; and a bootstrap switch coupled to the bootstrap driver and to the bootstrap capacitor component.

In Example 17, the subject matter of Example 16 includes, wherein: the bootstrap driver is coupled to the high side driver, to the power train, and to the bootstrap capacitor component; the bootstrap driver is further to generate a bootstrap switch control signal based on the inductor switching node voltage signal and the high side voltage signal; and the bootstrap switch and bootstrap driver generate the inductor switching node voltage signal based on the bootstrap switch control signal.

In Example 18, the subject matter of Example 17 includes, wherein the bootstrap driver is further to: determine when the inductor switching node voltage signal has returned to a base inductor voltage level; and the bootstrap switch control signal causes the inductive voltage output circuit to transition the output voltage from the second output level to the first output level when the inductor switching node voltage signal has returned to the base inductor voltage level.

In Example 19, the subject matter of Examples 17-18 includes, the bootstrap driver further including a high voltage clipper and a restorer circuit to generate a sensed clipped signal based on the inductor switching node voltage signal, wherein the bootstrap switch control signal is generated based on the sensed clipped signal.

In Example 20, the subject matter of Example 19 includes, wherein: the sensed clipped signal shares a plurality of voltage transitions with the inductor switching node voltage signal; and the sensed clipped signal includes a maximum clipped voltage that is lower than a maximum inductor voltage.

In Example 21, the subject matter of Examples 17-20 includes, the bootstrap driver further including: a level shifter and a delay circuit to generate a delayed signal based on the high side voltage signal; a first delayed switch circuit and a second delayed switch circuit to generate a switched signal based on the delayed signal; and a stacked driver stage to generate the bootstrap switch control signal based on the switched signal.

In Example 22, the subject matter of Examples 17-21 includes, wherein: the second charging phase includes discharging the bootstrap capacitor component and includes charging the inductor component; and the first charging phase includes charging the bootstrap capacitor component and includes discharging the inductor component.

In Example 23, the subject matter of Examples 17-22 includes, wherein the power train includes at least one of a gallium nitride (GaN) power train and a laterally-diffused metal-oxide semiconductor (LDMOS) power train.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

The subject matter of any Examples above may be combined in any combination.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus comprising:
a voltage converter to convert an input voltage into an output voltage, the voltage converter including:
a power train coupled to the input voltage and to an inductor component, the power train to generate an inductor switching node voltage signal;
a high side driver coupled to the power train and to the inductor component, the high side driver to generate a high side voltage signal;
a bootstrap driver coupled to the high side driver and to the power train, the bootstrap driver to generate a bootstrap switch control signal based on the inductor switching node voltage signal and the high side voltage signal;
a bootstrap capacitor component coupled to the high side driver and to the bootstrap driver; and
a bootstrap switch coupled to the bootstrap driver and to the bootstrap capacitor component, the bootstrap switch to transition the inductor component and the bootstrap capacitor component between a first charging phase and a second charging phase based on the bootstrap switch control signal.

2. The apparatus of claim 1, wherein the bootstrap driver is further to:
determine when the inductor switching node voltage signal has returned to a base inductor voltage level; and
the bootstrap switch control signal causes a transition from the second charging phase to the first charging phase when the inductor switching node voltage signal has returned to the base inductor voltage level.

3. The apparatus of claim 1, the bootstrap driver further including a high voltage clipper and a restorer circuit to generate a sensed clipped signal based on the inductor switching node voltage signal, wherein the bootstrap switch control signal is generated based on the sensed clipped signal.

4. The apparatus of claim 3, wherein:
the sensed clipped signal shares a plurality of voltage transitions with the inductor switching node voltage signal; and
the sensed clipped signal includes a maximum clipped voltage that is lower than a maximum inductor voltage.

5. The apparatus of claim 1, the bootstrap driver further including:
a level shifter and a delay circuit to generate a delayed signal based on the high side voltage signal;
a first delayed switch circuit and a second delayed switch circuit to generate a switched signal based on the delayed signal; and
a stacked driver stage to generate the bootstrap switch control signal based on the switched signal.

6. The apparatus of claim 1, wherein:
the second charging phase includes discharging the bootstrap capacitor component and includes charging the inductor component; and
the first charging phase includes charging the bootstrap capacitor component and includes discharging the inductor component.

7. The apparatus of claim 1, wherein the power train includes at least one of a gallium nitride (GaN) power train and a laterally-diffused metal-oxide semiconductor (LDMOS) power train.

8. A method comprising:
generating a high side voltage signal at a high side driver, the high side driver coupled to a power train and to an inductor component;
generating an inductor switching node voltage signal at the power train based on an input voltage, the power train coupled to the inductor component;
generating a bootstrap switch control signal at a bootstrap driver based on the inductor switching node voltage signal and the high side voltage signal, the bootstrap driver coupled to the high side driver and to the power train;
generating a bootstrap switch output signal at a bootstrap switch coupled to the bootstrap driver and to a bootstrap capacitor component; and
transitioning the inductor component and a bootstrap capacitor component between a first charging phase and a second charging phase in response to the bootstrap switch output signal.

9. The method of claim 8, further including determining, at the bootstrap driver, subsequent to generating the inductor switching node voltage signal, the inductor switching node voltage signal has returned to a base inductor voltage level;
wherein transitioning the inductor component and the bootstrap capacitor component includes causing a transition from the second charging phase to the first charging phase when the inductor switching node voltage signal has returned to the base inductor voltage level.

10. The method of claim 8, further including generating a sensed clipped signal, at a high voltage clipper and a restorer circuit within the bootstrap driver, the sensed clipped signal generated prior to the bootstrap switch control signal based on the inductor switching node voltage signal, wherein the bootstrap switch control signal is generated based on the sensed clipped signal.

11. The method of claim 10, wherein:
the sensed clipped signal shares a plurality of voltage transitions with the inductor switching node voltage signal; and
the sensed clipped signal includes a maximum clipped voltage that is lower than a maximum inductor voltage.

12. The method of claim 8, further including:
generating, at a level shifter and a delay circuit within the bootstrap driver, a delayed signal based on the high side voltage signal;
generating, at a first delayed switch circuit and a second delayed switch circuit within the bootstrap driver, a switched signal based on the delayed signal; and
generating, at a stacked driver stage within the bootstrap driver, the bootstrap switch control signal based on the switched signal.

13. The method of claim 8, wherein:
the second charging phase includes discharging the bootstrap capacitor component and includes charging the inductor component; and
the first charging phase includes charging the bootstrap capacitor component and includes discharging the inductor component.

14. The method of claim 8, wherein the power train includes at least one of a gallium nitride (GaN) power train and a laterally-diffused metal-oxide semiconductor (LDMOS) power train.

15. An apparatus comprising:
a voltage converter to generate an output voltage based on an input voltage, the voltage converter including:
an inductive voltage output circuit including an inductor component, the inductive voltage output circuit to generate an output voltage based on an inductor switching node voltage signal received at the inductor component; and
a bootstrap driver coupled to the inductive voltage output circuit, the bootstrap driver to generate the inductor switching node voltage signal;
wherein the inductor switching node voltage signal causes the inductive voltage output circuit to transition the output voltage between a first output level to a second output level.

16. The apparatus of claim 15, the voltage converter further including:
a power train coupled to the input voltage and to an inductor component, the power train to generate an inductor switching node voltage signal;
a high side driver coupled to the power train and to the inductor component, the high side driver to generate a high side voltage signal;
a bootstrap capacitor component coupled to the high side driver; and
a bootstrap switch coupled to the bootstrap driver and to the bootstrap capacitor component.

17. The apparatus of claim 16, wherein:
the bootstrap driver is coupled to the high side driver, to the power train, and to the bootstrap capacitor component;
the bootstrap driver is further to generate a bootstrap switch control signal based on the inductor switching node voltage signal and the high side voltage signal; and
the bootstrap switch and bootstrap driver generate the inductor switching node voltage signal based on the bootstrap switch control signal.

18. The apparatus of claim 17, wherein the bootstrap driver is further to:
determine when the inductor switching node voltage signal has returned to a base inductor voltage level; and
the bootstrap switch control signal causes the inductive voltage output circuit to transition the output voltage from the second output level to the first output level when the inductor switching node voltage signal has returned to the base inductor voltage level.

19. The apparatus of claim 17, the bootstrap driver further including a high voltage clipper and a restorer circuit to generate a sensed clipped signal based on the inductor switching node voltage signal, wherein the bootstrap switch control signal is generated based on the sensed clipped signal.

20. The apparatus of claim 19, wherein;
the sensed clipped signal shares a plurality of voltage transitions with the inductor switching node voltage signal; and
the sensed clipped signal includes a maximum clipped voltage that is lower than a maximum inductor voltage.
